(19) United States
(12) Patent Application Publication
(10) Pub. No.: US 2025/0381483 A1
(43) Pub. Date: Dec. 18, 2025

(54) NON-TRANSITORY RECORDING MEDIUM RECORDING INFORMATION PROCESSING PROGRAM, INFORMATION PROCESSING METHOD, AND INFORMATION PROCESSING DEVICE

(71) Applicant: KOEI TECMO GAMES CO., LTD., Yokohama-shi (JP)

(72) Inventor: Takeshi GEN, Kanagawa (JP)

(21) Appl. No.: 19/231,590

(22) Filed: Jun. 9, 2025

(30) Foreign Application Priority Data
Jun. 14, 2024 (JP) 2024-096874

(51) Int. Cl. A63F 13/56; A63F 13/2145; A63F 13/44

(52) U.S. Cl. CPC A63F 13/56; A63F 13/2145; A63F 13/44

(57) ABSTRACT

A non-transitory recording medium storing instructions that are executable by a processor to perform operations in a computer game in which a character performs a predetermined motion, the operations including: displaying the predetermined motion on a display; and dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

### CROSS-REFERENCE TO RELATED APPLICATION

This application is based on and claims priority under 35 USC 119 from Japanese Patent Application No. 2024-096874, filed on Jun. 14, 2024, the disclosure of which is incorporated by reference herein.

### BACKGROUND

### Technical Field

The present disclosure relates to a non-transitory recording medium recording an information processing program, an information processing method, and an information processing device.

### Related Art

JP 2023-113587 A discloses a battle royalty game to be played by a plurality of players.

### SUMMARY

An aspect of the present disclosure is a non-transitory recording medium storing instructions that are executable by a processor to perform operations in a computer game in which a character performs a predetermined motion, the operations including: displaying the predetermined motion on a display; and dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

### BRIEF DESCRIPTION OF THE DRAWINGS

FIG. 1 is a block diagram showing the hardware configuration of an information processing device according to an embodiment;

FIG. 2 is a block diagram showing an example of functional components of the information processing device according to the embodiment;

FIG. 3 is an explanatory diagram for explaining an example of a motion control process according to the embodiment;

FIG. 4 is an explanatory diagram for explaining another example of a motion control process according to the embodiment;

FIG. 5 is a schematic diagram showing an example configuration of a timing information database according to the embodiment;

FIG. 6 is a flowchart showing a flow of a motion control process according to the embodiment;

FIG. 7 is an explanatory diagram for explaining a motion control process according to another embodiment; and

FIG. 8 is a flowchart showing a flow of a motion control process according to the another embodiment.

### DESCRIPTION

The following is a description of an information processing device 10 according to the present embodiment.

### First Embodiment

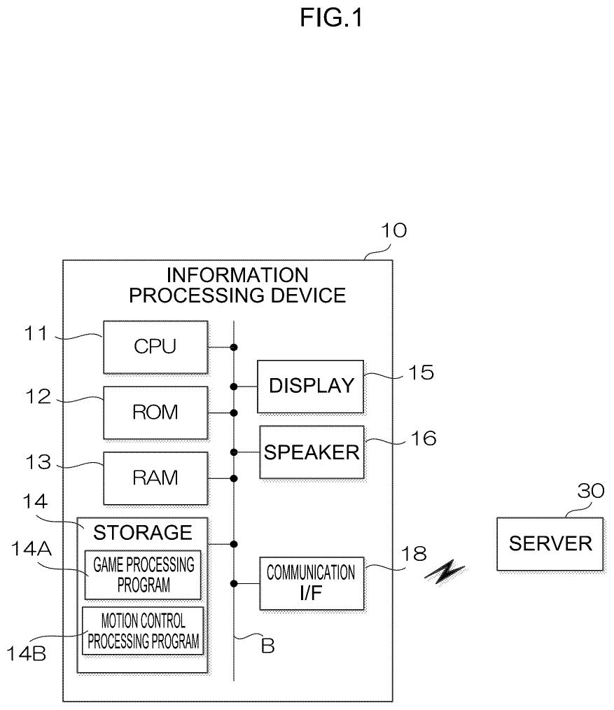

FIG. 1 is a block diagram showing the hardware configuration of the information processing device 10 according to the present embodiment. The information processing device 10 is a video game console, a portable game machine, a business game machine, a smartphone, a tablet terminal, or a personal computer, for example. In the present embodiment, the information processing device 10 is a “smartphone” as an example. The information processing device 10 is an example of a “computer” and an “information processing device” of the present disclosure.

As illustrated in FIG. 1, the information processing device 10 includes a central processing unit (CPU) 11, a read only memory (ROM) 12, a random access memory (RAM) 13, a storage 14, a display 15, a speaker 16, and a communication I/F 18. The respective components are communicably connected to one another via a bus B.

The CPU 11 is an example of a hardware processor, and executes various programs and controls each component.

The ROM 12, which is a non-transitory recording medium, is an example of a memory, and stores various programs and various kinds of data. The RAM 13, which is a non-transitory recording medium, is an example of a memory, and, as a work area, temporarily stores a program or data.

The storage 14, which is a non-transitory recording medium, is an example of a memory, is formed with a storage device such as a hard disk drive (HDD), a solid state drive (SSD), or a flash memory, and stores various programs and various kinds of data.

A game is played, for example, by a player using strategies and techniques to achieve a particular objective. Games are played to achieve various purposes including a competitive purpose such as winning, a battle purpose such as beating an enemy, an educational purpose such as learning, and a narrative purpose such as completing the progress of a scenario. A game may be in the form of competition or the form of non-competition.

The storage 14 also stores a game processing program 14A and a motion control processing program 14B. The CPU 11 loads the game processing program 14A and the motion control processing program 14B from the storage 14, and executes the game processing program 14A and the motion control processing program 14B, using the RAM 13 as the work area.

The display 15 is a liquid crystal display as an example, and displays various kinds of information. In the present embodiment, the display 15 integrally includes a touch panel, and the player can perform various operations via the touch panel. The speaker 16 reproduces the sound indicated by the sound data stored in the storage 14 during execution of a game. The communication I/F 18 is an interface for connecting the information processing device 10 to a network. For the communication I/F 18, a wireless communication standard such as 4G, 5G, 6G, 7G, or Wi-Fi (registered trademark) is used, for example.

Note that, in the present embodiment, the game processing program 14A and the motion control processing program 14B are downloaded and installed from an external server 30 via the communication I/F 18, but they are not limited to this mode. For example, these programs may be stored beforehand in the storage 14 of the information processing device 10, or the server 30 may be accessed so that these programs are executed every time a game is executed. The motion control processing program 14B is an example of an “information processing program” of the present disclosure, and a method for a motion control process to be executed in accordance with the motion control processing program 14B is an example of an “information processing method” of the present disclosure.

Since the information processing device 10 according to the present embodiment is a smartphone as described above, various kinds of information are displayed on the display 15, and various kinds of operations related to a game are performed on the touch panel provided on the display 15. However, it is not limited to this mode. For example, in a case where a device not including a display unit and an input unit in the main body is adopted as the information processing device 10, such as a stationary video game console, the display unit and the input unit may be externally connected thereto for use. In this mode, the display unit and the input unit may be detachable from the device main body.

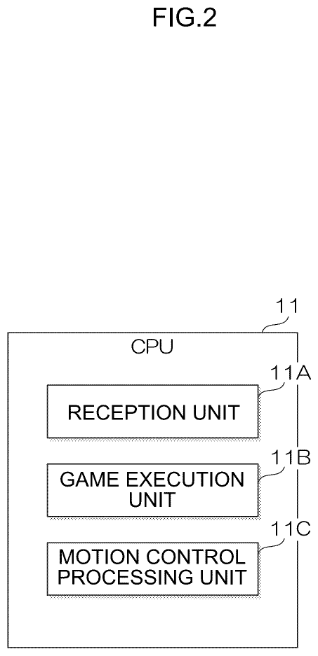

Next, functional components of the information processing device 10 are described. FIG. 2 is a block diagram showing an example of functional components of the information processing device 10.

As illustrated in FIG. 2, the CPU 11 of the information processing device 10 includes a reception unit 11A, a game execution unit 11B, and a motion control processing unit 11C as functional components. Each functional component is implemented by the CPU 11 reading and executing at least one of the game processing program 14A and the motion control processing program 14B stored in the storage 14.

The reception unit 11A receives, from the player, an input operation for a game using the touch panel.

The game execution unit 11B executes a predetermined game by executing the game processing program 14A stored in the storage 14. In the game, the volume of sound to be reproduced from the speaker 16 during the play can be set at a plurality of levels. The player can set the volume at a desired level by performing a predetermined input operation on the game using the touch panel.

The game according to the present embodiment is a battle game, and has a first mode in which the player fights against the CPU 11, and a second mode in which the player fights against a plurality of unspecified players online via the server 30.

Meanwhile, in a battle game or the like, there is a case where a motion resource is created beforehand for each type of motion of the characters who appear therein, and the motion of each character is controlled with the motion resource.

Conventionally, in a case where a motion of a character is controlled with a motion resource, when a motion of changing the orientation of the character is performed as a motion, for example, the character looks as if the character were placed on a turntable and were being rotated, and there is a feeling of strangeness to it.

For example, the following situation is considered. In a case where characters a, b, and c are present in a conversational event or the like, the character a performs expression of turning to the character c at the timing to start speaking to the character c from a state of speaking while facing the character b.

In a case where this situation is expressed with a conventional motion resource, expression of natural movement of the feet is abandoned, and the character a is rotated while the feet were fixed. In this case, however, it looks as if the character a were placed on a turntable and were being rotated, and there is a feeling of strangeness to it.

To solve this strangeness in the appearance, a method of newly creating a motion resource for turning the head of a character is also conceivable. In this case, however, the natural movement changes depending on the positions of the feet, and therefore, it is necessary to create a motion resource for each of all the poses so as to cause natural movement in all the poses. Furthermore, if the positions of the feet are bilaterally asymmetric in this case, there is the need to create both a motion resource for clockwise rotation and a motion resource for counterclockwise rotation.

Therefore, the motion control processing unit 11C according to the present embodiment divides a predetermined motion of a character into a plurality of motion elements including three types of motion elements: rotation of a first portion regarded as the center of gravity of the character, movement of the first portion, and movement of a second portion at which the character is grounded. The motion control processing unit 11C according to the present embodiment then controls the motion of the character for each element of the plurality of motion elements.

Under the control of the motion control processing unit 11C, the motion of a character can be controlled, without creation of a new motion resource.

Here, in the present embodiment, a motion of a character turning around is adopted as the predetermined motion. Note that the term “turning around” as used herein includes a motion of turning sideways or in an oblique direction, in addition to a motion of turning back.

Further, the motion control processing unit 11C according to the present embodiment individually controls at least one of the motion amount, the motion start timing, and the motion end timing (all of them, in this embodiment) for each element of the plurality of motion elements.

In particular, the motion control processing unit 11C according to the present embodiment individually controls at least one of the motion amount, the motion start timing, and the motion end timing (all of them, in this embodiment) for each element of the plurality of motion elements, while allowing at least one of an overlapping period and a separated period (allowing both in this embodiment) between different motion elements.

Furthermore, as the control on the predetermined motion, the motion control processing unit 11C according to the present embodiment controls motions of a plurality of imitation bones (hereinafter referred to as “bones”) that are compatible with the plurality of motion elements and imitate bones that move to perform the motions of the corresponding motion elements in the character. Note that a “bone” is one of the elements constituting a model of a character, and is a rod-like element disposed at substantially the same position as a bone of the character that is a human or the like. By moving the bone, the corresponding portion of a model (a model of an arm in the case of a bone of the arm, for example) of the character moves following the movement of the bone.

In the present embodiment, persons are adopted as the characters, but the embodiment is not limited to this mode. For example, deformed monsters, animals other than humans, or the like may be adopted as the characters.

In the following, an example of a process to be performed by the motion control processing unit 11C according to the present embodiment (this process will be hereinafter referred to as the “motion control process”) is specifically described.

In the present embodiment, the “hip” of a character is adopted as the first portion, and the “feet” of the character is adopted as the second portion.

That is, in the motion control processing unit 11C according to the present embodiment, a turning-back motion of a character is divided into three types of motion elements: rotation and movement of the bones of the hip (hereinafter referred to as the “hipbones”), and movement of the bones of the feet (hereinafter referred to as the “foot bones”) of the character. The motion control processing unit 11C according to the present embodiment then controls motions of the character for each of the three types of motion elements.

The basic idea of the motion control process according to the present embodiment is to consider a motion of a person turning around in the real world as a combination of motions of several bones, and reproduce the combination on a program.

For example, in a case where a person turns right by 90 degrees in the real world, the motions of the respective motion elements are performed in the following order in an overlapping manner, together with rotation of the body, for example.
1. The center of gravity shifts to the left foot
2. The right foot moves to the target point
3. The center of gravity shifts to the right foot
4. The left foot moves to the target point
5. The center of gravity returns to the original position

These motions can be roughly divided into three types: “1. rotation of the center of gravity”, “2. shifting of the center of gravity”, and “3. movement of the feet”.

When these motions are replaced with motions of a character model, the following is obtained.
1. Rotation of the center of gravity→rotation of the hipbones
2. Shifting of the center of gravity→movement of the hipbones
3. Movement of the feet→movement of the toe bones

Movement of these bones are controlled on the program, so that the appearance of the movement of the feet at the time of turning around is reproduced.

Note that, by generalizing the above bone operations as follows, application to a deformed monster model or the like other than a humanoid model also becomes possible.
1. Rotation of the bones of the portion regarded as the center of gravity
2. Movement of the bones of the portion regarded as the center of gravity
3. Movement of the bones of the grounded portion

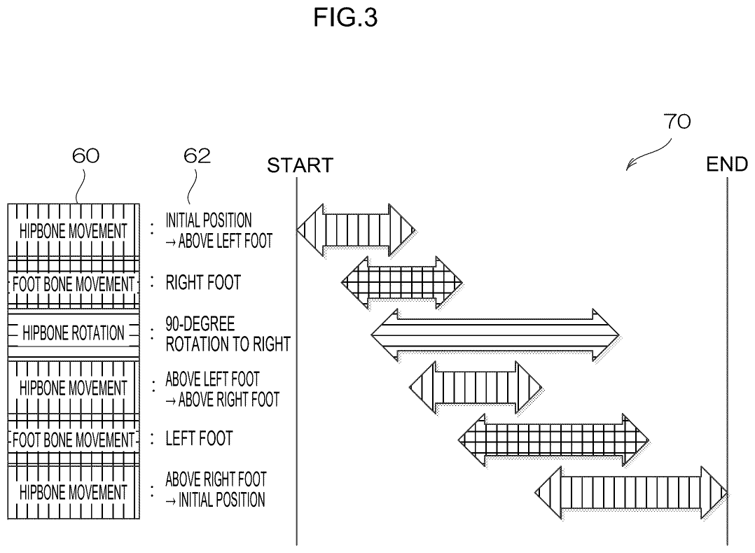

Referring next to FIG. 3, a specific example of the motion control process in a case where the above turning motion of a person is described. Note that FIG. 3 is an explanatory diagram for explaining an example of a motion control process according to the present embodiment.

Where the motion of turning to the right by 90 degrees is regarded as individual motions, each of rotation of the hipbones, movement of the hipbones, and movement of the foot bones (toe bone) in a motion element 60 is regarded as performing the following motions 62.
Hipbone rotation (body rotation): rotating 90 degrees to the right from the front
Hipbone movement (movement of the center of gravity): moving to immediately above the left foot bones→moving to immediately above the right foot bones→moving to the initial position
Foot bone movement (movement of the feet): moving of the right foot bones→moving of the left foot bones

These motions are combined, and a motion control process (more specifically, the individual control process in the motion control process as described later) is performed as illustrated in a timing chart 70 shown in FIG. 3 as an example, so that the motion of the feet at the time of turning around is reproduced on the program. Note that the horizontal axis in the timing chart 70 is the time axis.

As illustrated in FIG. 3, in the timing chart 70, the hipbones first start moving to a position above the left foot bones, the right foot bones start moving before the hipbones reach the target point, and further, rotation of the hipbones also starts.

When the movement of the hipbones to a position above the left foot bones is completed, movement of the respective motion elements such as starting the movement of the hipbones to a position above the right foot bones is executed in an overlapping manner. In this manner, a natural appearance is reproduced.

The timing to start and the timing to end each motion, and the amount of movement (motion amount) are determined on the program depending on the pose of the model to be rotated, so that a substantially natural appearance of any pose can be reproduced.

According to the study of the inventors, the movement of the foot bones would be more natural if the right foot bones are moved before the left foot bones in the case of a motion of turning to the right. This is because, in a case where a person turns to the right, the right foot is moved forward first as a natural motion of a human, and movement of the foot bones is assumed to start from movement of the right foot bones. Note that, in the case of a motion of turning to the left, the left foot bones are moved before the right foot bones. As the destination of the foot bones, the position of the foot bones after the character is rotated is calculated beforehand, and the foot bones are then moved to the position.

Further, as for the movement of the hipbones, in the case of turning to the right, a natural appearance would be obtained if the hipbones are moved from the initial position to a position above the left foot bones to a position above the right foot bones to the initial position. In the case of turning to the right, the right foot is moved before the left foot. Therefore, such movement would be obtained if the movement of the center of gravity is taken into consideration in this order. In the case of turning to the left, the order should be reversed. Note that, in the example illustrated in FIG. 3, the hipbones are continuously moved, but the embodiment is not limited to this mode, and there may be a timing to stop the movement halfway.

Further, regarding the rotation of the hipbones, it is not important whether the rotation of the hipbones is symmetrical about the center of the rotation of the hipbones on the timeline, and it looks more natural when the movement of the right foot bones is ended and the movement of the left foot bones is started at an early stage of the rotation (a stage of one third of the target rotation angle).

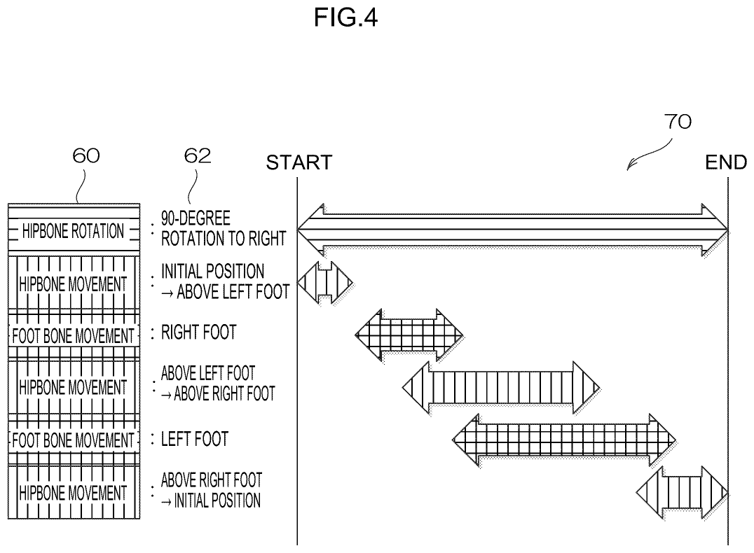

FIG. 4 is an explanatory diagram for explaining another example of the motion control process according to the present embodiment. Note that the example illustrated in FIG. 4 is an example case where the timing is adjusted so that a normal standing pose of the model of the character as the main character looks most natural with respect to the motion control process of performing the motion of turning to the right as illustrated in FIG. 3.

As illustrated in FIG. 4, in this motion control process, the rotation of the hipbones, which is performed immediately after the start of the movement of the foot bones of the right foot in the motion control process illustrated in FIG. 3, is started at the start of the motion, and the rotation of the hipbones is performed until the rotation of the character comes to an end.

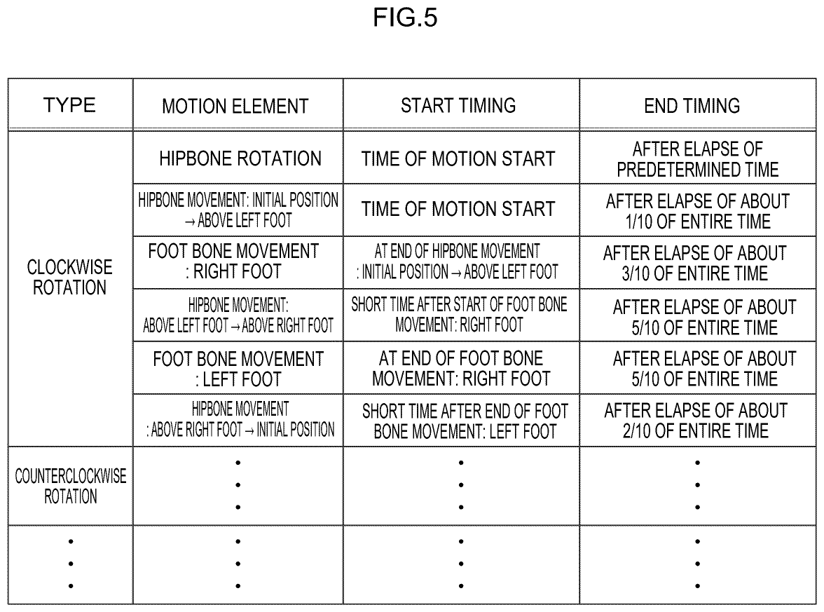

The timings of the start and the end of each motion element in this case are shown in FIG. 5 as an example. In the example illustrated in FIG. 5, regarding the rotation of the hipbones, the timing at the start of the corresponding turning motion is adopted as the start timing, and the timing after the lapse of a predetermined time as the period in which the turning motion ends is adopted as the end timing, for example.

In the description below, a case where the motion illustrated in FIG. 4 is performed is explained as the motion control process according to the present embodiment. Also, in the description below, a case where the information shown in FIG. 5 is adopted as information indicating each of the timings of the start and the end of each motion element in the motion control process according to the present embodiment is explained. In the present embodiment, the information indicating the timings of the start and the end of each motion element shown in FIG. 5 is registered beforehand in the storage 14 as a database (hereinafter referred to as the “timing information database”), together with information indicating the type of the corresponding motion. However, the embodiment is not limited to this mode. For example, the timing information database may be registered in an external device such as the server 30, and the database may be referred to if appropriate.

In the motion control process according to the present embodiment, the timing of the motion of each motion element is adjusted depending on the distance between the feet of the character and the angle at which the character turns around.

In the motion control process according to the present embodiment, in a case where the distance between the feet is longer than a predetermined threshold, adjustment is performed to advance the start of the movement of the right foot bones, and delay the end of the movement of the right foot bones. Also, in the motion control process according to the present embodiment, in a case where the turning angle is greater than a predetermined threshold, adjustment is performed to delay the start of the movement of the foot bones and the hipbones, and advance the end of the movement of the foot bones and the hipbones. Further, in the motion control process according to the present embodiment, adjustment is performed to increase the amount of movement of the hipbones when the turning angle is greater.

As this adjustment is performed, a more natural turning motion can be performed, compared with that in a case where the adjustment is not performed. Since this adjustment can be performed on the program, the adjustment can be performed more easily than that in a case where a motion resource is used. Note that the thresholds to be adopted in the adjustment may be set to fixed values in advance, or may be switched as appropriate in accordance with a game situation, a character type, or the like.

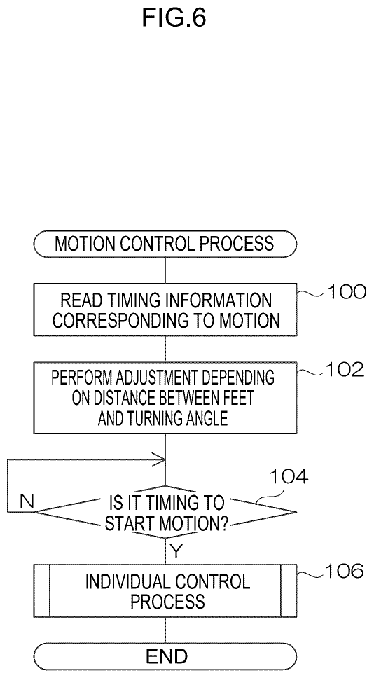

Referring next to FIG. 6, a flow of the motion control process is described. FIG. 6 is a flowchart showing a flow of the motion control process according to the present embodiment. The CPU 11 reads the motion control processing program 14B from the storage 14, loads the motion control processing program 14B into the RAM 13, and executes the motion control processing program 14B, so that the motion control process is performed. As an example, the motion control process is performed in a case where the game processing program 14A is executed by the game execution unit 11B, and a character (hereinafter referred to as the “target character”) performs a motion (hereinafter referred to as the “motion to be executed”). Note that, to avoid complication, a case where the type of the motion to be executed and the angle of rotation of the target character are set in advance is described herein.

In step 100 shown in FIG. 6, the CPU 11 reads, from the timing information database, each piece of information about the timings of starts and ends of all the motion elements corresponding to the motion to be executed (the information will be hereinafter referred to as the “timing information”).

In step 102, the CPU 11 acquires information indicating the distance between the feet and information indicating the angle of the target character turning around, and adjusts the start timing and the end timing indicated by the timing information as described above, using the acquired information.

In step 104, the CPU 11 waits until the timing to start the motion to be executed. In step 106, the CPU 11 performs an individual control process that is a process of individually controlling each motion element of the target character so as to perform the motion indicated by the timing information that has undergone the above process, and then ends the present motion control process. By the individual control process in step 106, the motion that is illustrated in the timing chart 70 shown in FIG. 4 as an example, and is the motion whose timing is adjusted by the process in step 102 is executed. Note that a process of executing the motion illustrated in the timing chart 70 in FIG. 4 without any change, the motion illustrated in the timing chart 70 in FIG. 3 without any change, a motion obtained by subjecting the motion to the adjustment in the process in step 102, or the like, instead of the above motion, may be adopted as the individual control process.

As described above, in a game in which a character performs a predetermined motion, the CPU 11 in the information processing device 10 divides the predetermined motion into a plurality of motion elements including three types of motion elements that are rotation of the first portion regarded as the center of gravity of the character, movement of the first portion, and movement of the second portion at which the character is grounded, and controls the motion of the character for each element of the plurality of motion elements. Thus, the motion of the character can be controlled, without creation of a new motion resource.

Also, in the information processing device 10, a motion of a character turning around is adopted as the predetermined motion. Thus, a motion of a character turning around can be controlled, without creation of a new motion resource.

Further, in the information processing device 10, the CPU 11 individually controls at least one of the motion amount, the motion start timing, and the motion end timing of each element of the plurality of motion elements. Thus, a motion closer to an actual motion than that in a case where the control target is not individually controlled can be expressed. As a result, a more natural motion can be expressed.

Also, in the information processing device 10, the CPU 11 individually controls at least one of the motion amount, the motion start timing, and the motion end timing of each element of the plurality of motion elements, while allowing at least one of an overlapping period and a separated period between different motion elements. Thus, a more natural motion can be expressed, compared with that in a case where control is performed without allowing any of an overlapping period and a separated period between motion elements.

Further, in the information processing device 10, as the control on the predetermined motion, the CPU 11 controls motions of a plurality of imitation bones that are compatible with the plurality of motion elements and imitate bones that move to perform the motions of the corresponding motion elements in the character. Thus, it is possible to obtain the effects of the technology of the present disclosure, using bones that have been conventionally used.

Furthermore, in the information processing device 10, persons are adopted as characters. Thus, natural motions can be expressed as motions of humans.

### Second Embodiment

As an example of a game machine, there is a machine that designates a position and a direction by moving a stick or a button forward, backward, right, and left. In a game machine of this type, when a character attacks, a beam is emitted forward while a button is pressed, and a character is rotated by an input using a stick, to adjust the direction of emission of the beam.

In this case, when the character is rotated by the player's input during the motion at the time of emitting the beam (the motion will be hereinafter referred to as the “loop motion”), the feet do not move from the position of the loop motion, and the character looks as if the character were placed on a turntable and were rotating.

That is, in the motion control process according to the first embodiment, the rotation angle of the character is set, so that the feeling of strangeness is reduced particularly in the appearance of the feet moving during the rotating motion in accordance with the rotation angle.

In this mode, however, it is necessary to designate the rotation angle in advance, it is not possible to cope with a situation in which the stick slowly rotates to the right little by little while the stick is tilted to the right by the player's operation.

Therefore, in the motion control process according to the present embodiment, a process is performed to make the motion of the character's feet natural in a case where the character during the loop motion is slowly rotated little by little in accordance with the player's input.

Because of this, in a case where the character has a torso and feet, and a motion of rotating the character is performed as the above motion, the motion control processing unit 11C according to the present embodiment makes the timing of the start of movement of the feet later than the timing of the start of rotation of the torso. Particularly, in the present embodiment, the timing at which the rotation angle of the torso becomes equal to or greater than a predetermined threshold is adopted as the timing of the start of movement of the feet. In the present embodiment, as the threshold, an angle at which the character rotates in a period of a predetermined proportion ( 1/10 in the present embodiment) of the period from the start of the rotating motion of the torso to the end of the rotating motion is adopted, but the embodiment is not limited to this mode. For example, the threshold may be set as a fixed value (30 degrees as an example).

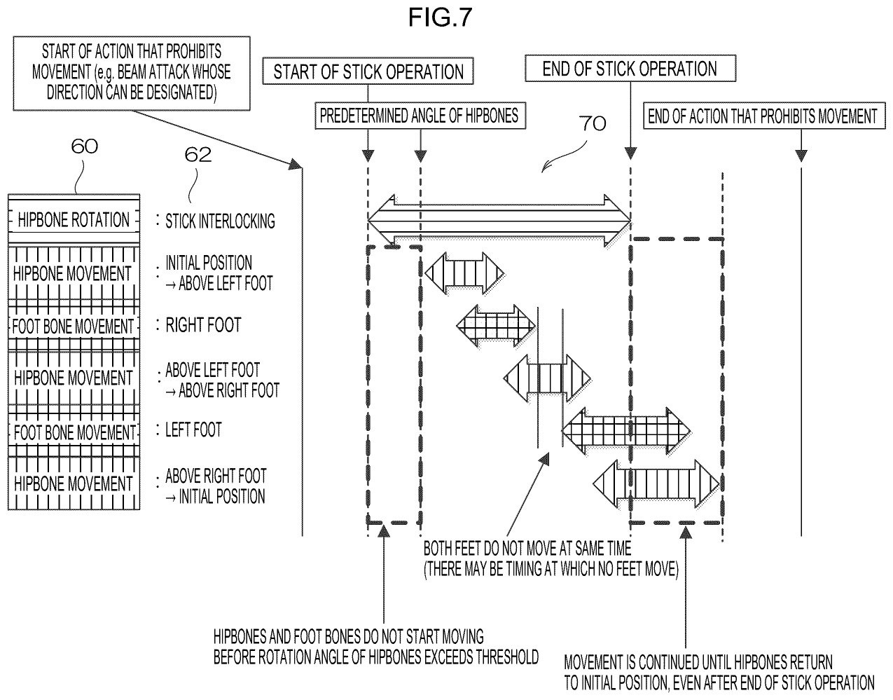

FIG. 7 is an explanatory diagram for explaining a motion control process according to the present embodiment.

As illustrated in FIG. 7, the motion control process according to the present embodiment differs from the motion control process according to the first embodiment illustrated in FIG. 4, in that rotation of the hipbones (which is rotation of the torso) interlocks with an operation of the stick. For example, in a case where an operation of the player tilting the stick to the right is received, the CPU 11 rotates the hipbones clockwise, and, in a case where an operation of the player tilting the stick to the left is received, the CPU 11 rotates the hipbones counterclockwise. Note that various kinds of buttons of the controller may be used, instead of the stick of the controller. In the motion control process according to the first embodiment, the reception of the rotation angle is used as the start point of a rotating motion. In the motion control process according to the present embodiment, on the other hand, the start of an operation on the stick by the player is used as the start point of a rotating motion.

In the motion control process according to the present embodiment, a stick operation by the player is then started, and movement of both the hipbones and the foot bones is not started before the rotation angle of the hipbones exceeds the threshold. Note that, in the motion control process according to the present embodiment, the movement is continued until the position of the hipbones returns to the initial position even when the stick operation by the player comes to an end. Further, as illustrated in FIG. 7, in the present embodiment, the right foot bones and the left foot bones may be prohibited from moving at the same time, or there may be a timing at which all the foot bones are prohibited from moving.

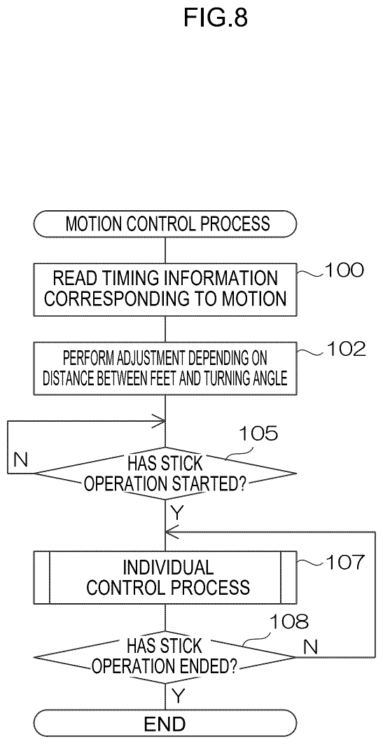

Referring next to FIG. 8, a flow of the motion control process according to the present embodiment is described. FIG. 8 is a flowchart illustrating a flow of the motion control process according to the present embodiment. Steps of performing the same processes as those in the flowchart according to the first embodiment illustrated in FIG. 6 are denoted by the same step numbers as those in FIG. 6, and explanation thereof is not made herein. As illustrated in FIG. 8, the motion control process according to the present embodiment differs from the motion control process according to the first embodiment in the process in and after step 105.

That is, in step 105 shown in FIG. 8, the CPU 11 waits until the player starts an operation on the stick.

In step 107, the CPU 11 performs an individual control process that is a process of individually controlling each motion element of the target character so as to perform the motion indicated by the timing information adjusted by the process in step 102.

In step 108, the CPU 11 determines whether the stick operation detected by the process in step 105 has ended. In a case where the determination result is negative, the process returns to step 107, and, in a case where the determination result is affirmative, this motion control process comes to an end.

By the individual control process in step 107, the motion that is illustrated in the timing chart 70 shown in FIG. 7 as an example, and is the motion whose timing is adjusted by the process in step 102 is executed. The individual control process to be performed here differs from the individual control process in step 106 in FIG. 6 according to the first embodiment, in that the rotation of the hipbones interlocks with the player's operation on the stick.

As described above, in a case where the character has a torso and feet, and a motion of rotating the character is performed as the above motion, the CPU 11 in the information processing device 10 according to the present embodiment makes the timing of the start of movement of the feet later than the timing of the start of rotation of the torso. Thus, in a case where a character has a torso and feet, and a motion of rotating the character is performed, a motion closer to the actual motion can be expressed, compared with that in a case where the timing of the start of movement of the feet is not later than the timing of the start of rotation of the torso. As a result, a more natural motion can be expressed.

Particularly, in the information processing device 10 according to the present embodiment, the timing at which the rotation angle of the torso becomes equal to or greater than a predetermined threshold is adopted as the timing of the start of movement of the feet. Thus, by changing the threshold, it is possible to express a rotating motion depending on the situation in which the character is placed.

Note that, in each of the above embodiments, the speed of a motion of a character has not been mentioned, but the start timing and the end timing of the motion may be formulated, with the speed of the motion being taken into account, for example.

Also, in each of the above embodiments, the motion control process performed by the CPU 11 loading software (a program) may be performed by various processors other than a CPU. Examples of the processors in this case include a programmable logic device (PLD) in which the circuit configuration can be changed after manufacturing, such as a field-programmable gate array (FPGA), and a dedicated electric circuit that is a processor having a circuit configuration designed exclusively for performing specific processing, such as an application specific integrated circuit (ASIC). Also, the motion control process may be performed by one of these various processors, or may be performed by a combination of two or more processors of the same type or different types (a plurality of FPGAs, a combination of a CPU and an FPGA, or the like). More specifically, the hardware structure of any of these various processors is an electric circuit in which circuit elements such as semiconductor elements are combined.

In a battle-type gate such as a battle royal game, there are cases where a motion resource is created beforehand for each type of motion of the characters who appear therein, and the motion of each character is controlled with the motion resource. Note that a “motion resource” as used herein means information in which the layout (including positions and orientations) of a plurality of bones that are related to one another and will be described in detail later is set in advance in a series of frames.

As for methods of creating a motion resource, one of two types of methods, which are a method of manually creating a motion resource using a three-dimensional model, and a method of creating a motion resource by motion capture, is mainly adopted. A motion resource is a type of data to be used in a game, and is similar to background music (BGM), sound effects (SE), a movie to be reproduced in an event scene, or the like. As these pieces of data are included in the game, each piece of the data can be used as appropriate during execution of the game, and the motion resource can cause a character to perform a motion in the game.

In a conventional case where a motion of a character is controlled with a motion resource as described above, when a motion of changing the orientation of the character is performed as the motion, for example, the orientation of the character is changed while the angle of the feet or the like remains fixed. Therefore, in this case, the character looks as if the character were placed on a turntable and were being rotated, and there is a feeling of strangeness to it.

Since a motion resource allows only motions as created, there is a problem in that it is necessary to newly create a motion resource for each type of motion in a case where the motion resource is to be used to solve the above strangeness in appearance. Because creation of a large number of motion resources would lead to compression of the memory, it is preferable to avoid the creation as much as possible.

Therefore, the present disclosure aims to provide a non-transitory recording medium recording an information processing program for controlling a motion of a character without creating a new motion resource, an information processing method, and an information processing device.

A first aspect of the present disclosure is a non-transitory recording medium storing instructions that are executable by a processor to perform operations in a computer game in which a character performs a predetermined motion, the operations including: displaying the predetermined motion on a display; and dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

A second aspect of the present disclosure is the non-transitory recording medium of the first aspect, wherein the predetermined motion is a motion of the character turning around.

A third aspect of the present disclosure is the non-transitory recording medium of the first aspect, the operations further comprising individually controlling at least one of a motion amount, a motion start timing, or a motion end timing of each element of the plurality of motion elements.

A fourth aspect of the present disclosure is the non-transitory recording medium of the third aspect, the operations further comprising individually controlling at least one of the motion amount, the motion start timing, or the motion end timing of each element of the plurality of motion elements, while allowing at least one of an overlapping period or a separated period among different motion elements.

A fifth aspect of the present disclosure is the non-transitory recording medium of the first aspect, wherein, when the character has a torso and feet, and a motion of rotating the character is performed as the motion, a movement start timing of the feet is set to be later than a rotation start timing of the torso.

A sixth aspect of the present disclosure is the non-transitory recording medium of the fifth aspect, wherein the movement start timing of the feet is a timing at which a rotation angle of the torso becomes equal to or greater than a predetermined threshold.

A seventh aspect of the present disclosure is the non-transitory recording medium of the first aspect, the operations further including, as a control for the predetermined motion, controlling motions of a plurality of imitation bones, the imitation bones respectively moving corresponding to the plurality of motion elements in the character.

A eighth aspect of the present disclosure is the non-transitory recording medium of the first aspect, wherein the character is a person.

A ninth aspect of the present disclosure is the non-transitory recording medium of the first aspect, the operations further including: receiving an operation performed by a player of the game via an input device; and controlling the motion of the character for each element of the plurality of motion elements, based on the received operation.

A tenth aspect of the present disclosure is an information processing method executed by a processor of a computer to perform operations in a computer game in which a character performs a predetermined motion, the operations including: displaying the predetermined motion on a display; and dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

An eleventh aspect of the present disclosure is an information processing device including: a memory; and a processor coupled to the memory, wherein, in a computer game in which a character performs a predetermined motion, the processor is configured to: display the predetermined motion on a display; and divide the predetermined motion into a plurality of motion elements including three types of motion elements that are rotation of a first portion that serves as a center of gravity of the character, movement of the first portion, and movement of a second portion at which the character is in contact with the ground, and control the predetermined motion displayed on the display for each element of the plurality of motion elements.

With a non-transitory recording medium recording an information processing program, an information processing method, and an information processing device according to the present disclosure, it is possible to control motions of characters, without creating a new motion resource.

What is claimed is:

1. A non-transitory recording medium storing instructions that are executable by a processor to perform operations in a computer game in which a character performs a predetermined motion, the operations comprising:
displaying the predetermined motion on a display; and
dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

2. The non-transitory recording medium of claim 1, wherein the predetermined motion is a motion of the character turning around.

3. The non-transitory recording medium of claim 1, the operations further comprising individually controlling at least one of a motion amount, a motion start timing, or a motion end timing of each element of the plurality of motion elements.

4. The non-transitory recording medium of claim 3, the operations further comprising individually controlling at least one of the motion amount, the motion start timing, or the motion end timing of each element of the plurality of motion elements, while allowing at least one of an overlapping period or a separated period among different motion elements.

5. The non-transitory recording medium of claim 1, wherein, when the character has a torso and feet, and a motion of rotating the character is performed as the motion, a movement start timing of the feet is set to be later than a rotation start timing of the torso.

6. The non-transitory recording medium of claim 5, wherein the movement start timing of the feet is a timing at which a rotation angle of the torso becomes equal to or greater than a predetermined threshold.

7. The non-transitory recording medium of claim 1, the operations further comprising, as a control for the predetermined motion, controlling motions of a plurality of imitation bones, the imitation bones respectively moving corresponding to the plurality of motion elements in the character.

8. The non-transitory recording medium of claim 1, wherein the character is a person.

9. The non-transitory recording medium of claim 1, the operations further comprising:
receiving an operation performed by a player of the computer game via an input device; and
controlling the motion of the character for each element of the plurality of motion elements, based on the received operation.

10. An information processing method executed by a processor of a computer to perform operations in a computer game in which a character performs a predetermined motion, the operations comprising:
displaying the predetermined motion on a display; and
dividing the predetermined motion into a plurality of motion elements including three types of motion elements that are rotation of a first portion that serves as a center of gravity of the character, movement of the first portion, and movement of a second portion at which the character is in contact with the ground, and controlling the predetermined motion displayed on the display for each element of the plurality of motion elements.

11. An information processing device comprising:
a memory; and
a processor coupled to the memory, wherein,
in a computer game in which a character performs a predetermined motion,
the processor is configured to:
display the predetermined motion on a display; and
divide the predetermined motion into a plurality of motion elements including three types of motion elements that are rotation of a first portion that serves as a center of gravity of the character, movement of the first portion, and movement of a second portion at which the character is in contact with the ground, and control the predetermined motion displayed on the display for each element of the plurality of motion elements.
